(19) United States
(12) Patent Application Publication
(10) Pub. No.: US 2008/0307788 A1
(43) Pub. Date: Dec. 18, 2008

(54) Internal Combustion Engine with a Turbocharger

(75) Inventor: Hiroyuki Hokuto, Shizuoka-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi ,Aichi-ken (JP)

(21) Appl. No.: 12/094,998

(22) PCT Filed: Dec. 13, 2006
(86) PCT No.: PCT/IB2006/003592

§ 371 Date: May 27, 2008

(30) Foreign Application Priority Data
Dec. 14, 2005 (JP) 2005-360274

(51) Int. Cl. F02G 3/00

(52) U.S. Cl. 60/624; 60/302

(57) ABSTRACT

A multi-cylinder internal combustion engine including a plurality of banks and a turbocharger is oriented laterally within an engine compartment, wherein exhaust gas passages are connected to exhaust manifolds of each bank, a turbine of the turbocharger is installed in the exhaust gap passage of the bank positioned closest to the front side of the vehicle, and the turbocharger is disposed at a front position within the engine compartment.

### BACKGROUND OF THE INVENTION

1. Field of the Invention

The present invention relates to an internal combustion engine with a turbocharger.

2. Description of the Related Art

An in-line multi-cylinder internal combustion engine with a turbocharger oriented laterally in the engine compartment so that the exhaust manifold side is toward the front side of the vehicle, and with the turbine and the compressor of the turbocharger disposed toward the front side of the vehicle in the engine compartment has been described, for example, in Japanese Patent Application Publication No. 63-093623 (1988). Using the described configuration, it is possible not only to make the length of the engine compartment relatively short, but also to cool the turbocharger with the airflow through the engine compartment.

In a V-type multi-cylinder internal combustion engine having two banks of cylinders, the turbine of the turbocharger is generally disposed downstream from the flow joining part of the exhaust gas passages of the two banks. For this reason, lateral orientation of the internal combustion engine together with the turbocharger disposed toward the front side of the vehicle in the engine compartment is difficult to implement because of the extreme length of the exhaust gas passage from the bank toward the rear of the engine up to the flow joining part.

### SUMMARY OF THE INVENTION

The present invention enables, in a multi-cylinder internal combustion engine having both a plurality of banks and a turbocharger, easy lateral placement of the internal combustion engine and placement of the turbocharger toward the front side of the vehicle.

A first aspect of the present invention relates to an internal combustion engine, having a plurality of banks, that is equipped with a turbocharger. The internal combustion engine is a multi-cylinder internal combustion engine. The internal combustion engine has an exhaust gas passage connected to exhaust manifolds provided on each of the banks. The internal combustion engine is oriented laterally in the engine compartment (in a direction in which the direction of extension of the crankshaft is perpendicular to the longitudinal vehicle direction). Additionally, the turbine of the turbocharger is installed in the exhaust gas passage of the bank that is closest to the front side of the vehicle, and the turbocharger is disposed at a front position within the engine compartment.

The first aspect of the present invention has a catalytic apparatus disposed near the engine itself in the exhaust gas passage of the bank nearest the rear of the vehicle, and may operate only the bank disposed closest to the rear of the vehicle when the engine is started.

The first aspect of the present invention may close the intake valve and the exhaust valve of the bank disposed toward the front of the vehicle when the engine is started.

The first aspect of the present invention may close the throttle valve connected to the bank disposed toward the front of the vehicle when the engine is started.

The first aspect of the present invention may further have a catalytic apparatus disposed in the exhaust gas passage of the bank disposed toward the rear of the vehicle.

The present invention relates to an internal combustion engine, equipped with a turbocharger, having a plurality of banks. Because the internal combustion engine is disposed laterally within the engine compartment, the length of the engine compartment is relatively short, compared to when the engine is disposed longitudinally. An exhaust gas passage for each bank is connected to the exhaust manifold of each bank, and the turbine of the turbocharger is installed in the exhaust gas passage of the bank that is disposed closest to the front of the vehicle. For this reason, it is not necessary to arrange the exhaust gas passage of the bank that is disposed to the rear of the vehicle to come around the front of the vehicle in order to dispose the turbocharger at a front position in the engine compartment. As a result, it is easy to achieve lateral orientation of the internal combustion engine and cooling of the turbocharger by the running wind.

In the internal combustion engine with a turbocharger, a catalytic apparatus may be disposed near the engine itself in the exhaust gas passage of the bank nearest the rear side of the vehicle. This catalytic apparatus is not easily cooled by the running wind, and it is easy for the temperature to increase to the catalyst activation temperature when the engine is started. For this reason, it is possible to achieve good purification of the exhaust gas from the bank that is disposed closest to the rear of the vehicle, which is operated when the vehicle is started. Because the bank disposed toward the front of the vehicle is not activated when the engine is starts, the catalytic apparatus does need not be disposed in the exhaust gas passage of the other bank close to the front of the vehicle.

### BRIEF DESCRIPTIONS OF THE DRAWINGS

The foregoing and further objects, features, and advantages of the invention will become apparent from the following description of preferred embodiments with reference to the accompanying drawings, wherein like numerals are used to represent like elements and wherein:

FIG. 1 is a simplified view of an internal combustion engine with a turbocharger according to an embodiment of the present invention.

### DETAILED DESCRIPTION OF PREFERRED EMBODIMENTS

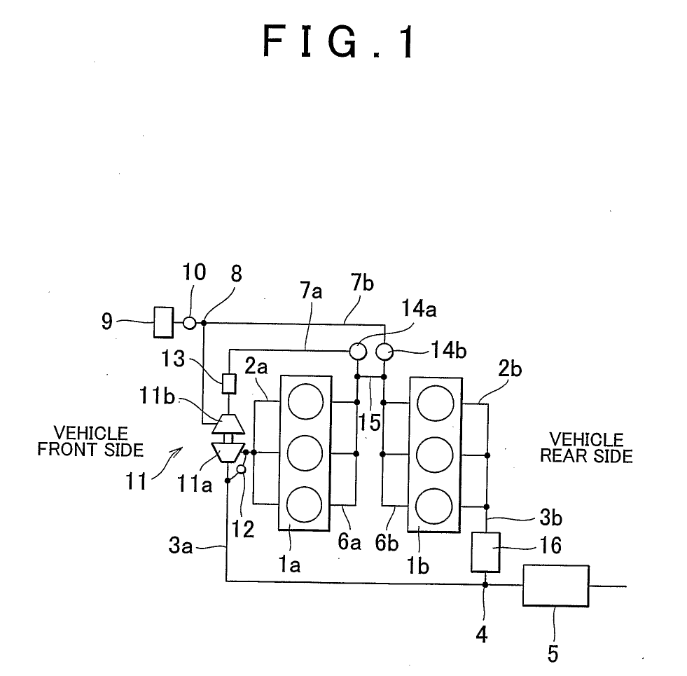

FIG. 1 is a simplified view of an internal combustion engine with a turbocharger according to an embodiment of the present invention. The internal combustion engine with a turbocharger of this embodiment is a V-type multi-cylinder internal combustion engine having a first bank 1a and a second bank 1b, and also having a first exhaust manifold 2a of the first bank 1a and a second manifold 2b of the second bank 1b. A first exhaust gas passage 3a is connected to the first exhaust manifold 2a and second exhaust gas passage 3b is connected to the second exhaust manifold 2b. The first exhaust gas passage 3a and the second exhaust gas passage 3b join at the exhaust gas joining part 4, and a main catalytic apparatus 5 is disposed downstream from the exhaust gas joining part 4.

As shown in FIG. 1, a first intake manifold 6a is connected to the first bank 1a, and a second intake manifold 6b is connected to the second bank 1b. A first intake passage 7a is connected to the first intake manifold 6a, and a second intake passage 7b is connected to the second intake manifold 6b. The first intake passage 7a and the second intake passage 7b branch at the intake branch part 8. An air cleaner 9 is connected upstream from the intake branch part 8. An air flow meter 10 for the purpose of detecting the intake amount is disposed between the intake branch part 8 and the air cleaner 9.

The V-type internal combustion engine is oriented laterally within the engine compartment, with the first bank 1a toward the front of the vehicle and the second bank 1b toward the rear of the vehicle. Lateral orientation in the engine compartment is the orientation of the engine so that the extension direction of the crankshaft is perpendicular to the vehicle longitudinal direction. By orienting the engine laterally, it is possible to shorten the engine compartment compared to longitudinal orientation, in which the extension direction of the crankshaft is parallel with the vehicle longitudinal direction.

The V-type internal combustion engine has a turbocharger 11 for achieving supercharging. The turbine 11a of the turbocharger 11 is disposed in the first exhaust gas passage 3a connected to the first bank 1a at the front side of the vehicle. By doing this, the turbocharger 11 can be easily oriented at a front position within the engine compartment, without bringing the exhaust gas passage 3b around. Good cooling of the turbocharger 11 can be achieved by the running wind. For this reason, when the load on the engine is large, for example, because melting damage to the turbine 11a is prevented, it is possible to suppress excessive fuel consumption such as making the air-fuel ratio rich, for the purpose of lowering the exhaust gas temperature. A waste gate valve 12 is disposed in a waste gate passage that bypasses the turbine 11a. The waste gate valve 12 controls the supercharging pressure by adjusting the amount of exhaust gas passing through the turbine 11a.

A compressor 11b of the turbocharger 11 is disposed in the first intake passage 7a. An intercooler 13 is disposed downstream from the compressor 11b of the first intake passage 7a to cool the supercharged intake air from the compressor 11b. A first throttle valve 14a is disposed downstream from the intercooler 13 in the first intake passage 7a, and a second throttle valve 14b is disposed in the second intake passage 7b. The first intake passage 7a and the second intake passage 7b are mutually connected by a connecting passage 15 disposed downstream from the first throttle valve 14a and the second throttle valve 14b. The connecting passage 15 enables the supercharged intake air from the compressor 11b of the first intake passage 7a to be supplied to the second bank 1b as well, via the second intake manifold 6b.

This V-type internal combustion engine mainly performs operation at a stoichiometric air-fuel ratio. In this embodiment, the main catalytic apparatus 5 is a three-way catalytic apparatus. Although the main catalytic apparatus 5 is relatively large, this does not present a problem in installation, because it is disposed below the floor of the vehicle. If the catalyst carried by the main catalytic apparatus 5 is maintained at the activation temperature, the exhaust gas exhausted from the first bank 1a and the second bank 1b is purified well by the main catalytic apparatus 5.

Immediately after starting the engine, however, the temperature of the main catalytic apparatus 5 does not immediately reach the catalyst activation temperature, and the main catalytic apparatus 5 cannot purify the exhaust gas until it reaches the catalyst activation temperature. The exhausting of the exhaust gas as is into the atmosphere during this period of time is undesirable from the standpoint of the environment. In such cases, a small auxiliary catalytic apparatus having a small heat capacity is generally disposed in the vicinity of the engine itself and, at the time of engine starting, this auxiliary catalytic apparatus is brought quickly to the catalyst activation temperature to handle the purification of the exhaust gas.

In this embodiment, such an auxiliary catalytic apparatus 16 is disposed near the engine itself near the second exhaust gas passage 3b connected to the second bank 1b at the rear side of the engine. By doing this, it is easy to dispose the auxiliary catalytic apparatus 16 in a position in which the running wind is blocked by the engine itself and does not strike the catalytic apparatus 16, and it is possible to easily cause rise of the temperature thereof when the engine is started. Also, the exhaust gas flowing into the auxiliary catalytic apparatus 16 does not experience a decrease in temperature caused by the turbine 11a such as in the case in which the auxiliary catalytic apparatus 16 is disposed in the first intake passage 3a. For this reason, disposing the auxiliary catalytic apparatus 16 in the second exhaust gas passage 3b is advantageous in terms of temperature rise.

This embodiment, by disposing such an auxiliary catalytic apparatus 16 in only the second exhaust gas passage 3b, operates only the second bank 1b at the time of engine starting. By doing this, the exhaust gas from the second bank 1b at the time of engine starting is purified well by the auxiliary catalytic apparatus 16, which is disposed in the second exhaust gas passage 3b and which quickly rises to the catalyst activation temperature. If the main catalytic apparatus 5 rises in temperature to the catalyst activation temperature by the exhaust gas passing through the auxiliary catalytic apparatus, even if operation of the first bank 1b is started, the exhaust gas of the first bank 1b can be purified by the main catalytic apparatus 5.

In this embodiment, the length up to exhaust flow joining part 4 from second exhaust gas passage 3b of the second bank 1b is shorter than from the first exhaust gas passage 3a of the first bank 1a. For this reason, when single-bank operation is done at the time of engine starting, it is advantageous from the standpoint of temperature rise in the main catalytic apparatus 5 to operate the second bank 1b so as to cause flow of the exhaust gas into the main catalytic apparatus 5 without cooling it excessively. At the time of engine startup starting control may be performed so as to increase the exhaust gas temperature, by an increase in the idling rpm by the igniting timing retard angle or an increase in the intake air and fuel.

When operating only the second bank 1b at the time of engine starting, it is sufficient to stop the fuel injection and ignition of the first bank 1a. When each of the intake valves and exhaust valves of the first bank 1a are opened and closed, the turbine 11a of the turbocharger 11 acts as a exhaust resistance and the compressor 11b acts as an intake resistance, the result being a worsening of engine starting. Because of this, it is preferable that the cam actuation not be transmitted to the intake valves and exhaust valves, or that the linkage between the cams and the camshaft be interrupted, so that the intake valves and exhaust valves remained closed. By doing this, pumping loss does not occur in the first bank 1a.

In the first embodiment, the first intake passage 7a of the first bank 1a and the second intake passage 7b of the second bank 1b are mutually independent. When operating only the second bank 1b at the time of engine starting, the first throttle valve 14a of the first intake passage 7a is fully closed (opening angle zero) and throttle angle control is performed of the second throttle valve 14b of the second intake passage 7b so as to control the amount of intake air supplied to the second bank 1b.

When the temperature of the main catalytic apparatus 5 reaches the catalyst activation temperature so that supercharged operation is done, the second throttle valve 14b of the second intake passage 7b is fully closed (opening angle zero). The supercharged intake air passing through the first intake passage 7a in which the compressor 11b of the turbocharger 11 is disposed is supplied to the first bank 1a and the second bank 1b by control of the opening of the first throttle valve 14a.

Although the main catalytic apparatus 5 in the foregoing embodiment is a three-way catalytic apparatus, if the internal combustion engine is operating with a lean burn, this may be made a NOₓ catalytic apparatus. In this case, if the operation is done with a stoichiometric air-fuel ratio or a rich air-fuel ratio when, for example, there is a very large load, it is preferable that the main catalytic apparatus be made a three-way catalytic apparatus and a NOₓ catalytic apparatus disposed in series.

Although the internal combustion engine in this embodiment is a V-type engine having two banks, the present invention is not restricted in this manner, and may be an internal combustion engine having a plurality of banks, for example, a W-type internal combustion engine having three banks. In these cases, in the laterally oriented engine, the turbine of turbocharger can be disposed in the exhaust gas passage of the bank that is closest to the front of the vehicle, the auxiliary catalytic apparatus can be disposed in the exhaust gas passage of the bank positioned closest to the rear of the vehicle, and if the only the bank that is positioned closest to the rear side of the vehicle is operated at the time of engine starting, it is possible to achieve the above-described effect of the present invention.

While the invention has been described with reference to what are considered to be preferred embodiments thereof, it is to be understood that the invention is not limited to the disclosed embodiments or constructions. On the contrary, the invention is intended to cover various modification and equivalent arrangements. In addition, while the various elements of the disclosed invention are shown in various combinations and configurations, which are exemplary, other combinations and configurations, including more, fewer, or only a single element, are also within the spirit and scope of the invention.

1-6. (canceled)

7. An internal combustion engine oriented laterally within an engine compartment, comprising:
a plurality of banks;
an exhaust gas passage connected to exhaust manifolds provided at each of the banks;
a turbocharger including a turbine disposed in the exhaust gas passage of a bank closest to the front side of a vehicle, oriented in the vehicle longitudinal direction within the engine compartment; and
a catalytic apparatus disposed near the engine itself in the exhaust gas passage of a bank nearest the rear side of the vehicle,
wherein only the bank disposed closest to the rear side of the vehicle is operated when the engine is started.

8. The internal combustion engine according to claim 7, wherein
an intake valve and an exhaust valve of a bank disposed toward the front side of the vehicle are closed when the engine is started.

9. The internal combustion engine according to claim 7, wherein
a throttle valve connected to a bank disposed toward the front side of the vehicle is closed when the engine is started.

10. The internal combustion engine according to claim 7, wherein:
the catalytic apparatus disposed in the exhaust gas passage of a bank is disposed toward the rear side of the vehicle.
